(19) United States
(12) Patent Application Publication
(10) Pub. No.: US 2020/0021163 A1
(43) Pub. Date: Jan. 16, 2020

(54) HEAT SINK FOR ROTARY ELECTRIC MACHINE

(71) Applicant: INSTITUT VEDECOM, VERSAILLES (FR)

(72) Inventors: Dominique LHOTELLIER, Ville d'Avray (FR); Guy DIEMUNSCH, Fontaine (FR)

(21) Appl. No.: 16/336,380

(22) PCT Filed: Sep. 18, 2017
(86) PCT No.: PCT/FR2017/052485

§ 371 Date: Mar. 25, 2019

(30) Foreign Application Priority Data
Sep. 28, 2016 (FR) 1659176

(51) Int. Cl. H02K 5/18; H02K 9/22; H02K 3/24

(52) U.S. Cl. CPC H02K 5/18; H02K 3/24; H02K 9/22

(57) ABSTRACT

The invention relates to a heat sink (10) for a rotary electric machine comprising: —a first portion (1) that is configured to make contact with a coil head (105) of the rotary electric machine; —a second portion (2), separate from the first portion (1), providing an exchange of heat with an outside environment, the second portion (2) being thermally coupled to the first portion (1), characterized in that the first portion (1) is configured to be housed inside a recess delimited by the coil head. Said invention is applicable to motor vehicles.

### CROSS-REFERENCE TO RELATED APPLICATIONS

This application is the US National Stage under 35 USC § 371 of International Application No. PCT/FR2017/052485, filed 18 Sep. 2017 which claims priority to French App. No. 1659176, filed on 28 Sep. 2016, the content (text, drawings and claims) of both being incorporated here by reference.

### BACKGROUND

The field of the present application is heat sinks, and more particularly heat sinks for rotary electric machines, such as generators or motors. More particularly, these electric machines are intended to be installed on vehicles, in particular motor vehicles.

The rotary electric machines, such as generators or motors, comprise a stator and a rotor. Windings forming coils are mounted on the stator and, for example, permanent magnets are fixed to the rotor. The rotor can be rotated by means of a shaft. When the electric machine is a generator, the rotational movement of the rotor facing the coils of the stator makes it possible to generate electrical energy, and when the electric machine is a motor, rotating the rotor by means of the coils generates mechanical energy.

In the event of these electric machines being used to move an electric vehicle, it is expedient to minimize the weight of all the elements onboard the vehicle, because this weight has a direct impact on the endurance of an electric power source intended for supplying the electric machine for driving the vehicle. Seeking in this way to reduce the weight is reflected in an optimization of the compactness of this electric machine, while maintaining the same level of performance.

This situation results in an increase in the heat density produced by the electric machine. It is therefore necessary to cool this electric machine in order to prevent overheating which may result in a reduction in performance, or even destruction of the electric machine.

Among the components of the electric machine that are to be cooled, the coils should be mentioned, and more particularly the coil heads. These components are critical elements which dictate the level of the general performance of the electric machine. While keeping this size reduction of the electric machine in mind, it becomes particularly difficult to cool these components effectively.

### SUMMARY

This technical problem is solved by a heat sink for a rotary electric machine, comprising:
a first part that is designed to be in contact with a coil head of the rotary electric machine,
a second part which is separate from the first part, ensuring heat exchange with an external environment, the second part being thermally coupled to the first part, wherein the first part is designed to be accommodated inside a cavity delimited by the coil head.

“Thermally coupled” means that heat exchange is possible between the first and the second part. In other words, the first and the second part are mechanically connected, and the second part is involved in cooling the first part.

The heat sink is advantageously formed in one piece. That is to say that the first part, the second part, and optionally a base that is common to these two parts, are integral, i.e. formed simultaneously and from the same material, for example a thermally conductive material such as an aluminum-based alloy. Such a structure eliminates any thermal interface on the heat flow path within the sink according to the invention.

A heat sink of this kind, accommodated inside a hollow formed by the coil head, makes it possible to ensure a maximum heat exchange surface, which provides for improved cooling and is particularly well suited to an electric machine of a reduced size. The cavity is delimited on one side by the coil head, and on the other side by the stator lamination stack.

A rotary electric machine is understood as being different from a linear electric machine.

It is also possible that the first part may be designed to be in contact with a plurality of coil heads. Indeed, this first part could be U-shaped for example.

According to different features of the heat sink, taken individually or in combination, it may be possible that:
the first part and the second part extend from a common base, each of the parts extending from an opposite face of the common base. The first part thus extends from a lower face of the common base, while the second part extends from an upper face of the common base.
the common base is designed to be in contact with an upper surface of the coil head. The upper surface of the coil head is defined as being the surface of the coil head that is furthest from the axis of rotation of the electric machine.
the second part comprises at least one blade that ensures heat exchange with the external environment. The presence of the blade makes it possible to increase the heat exchange surface between the second part and the external environment, and the cooling is thus improved. The at least one blade is designed to extend radially and towards the outside of the rotary machine.
the second part comprises a plurality of blades that extend along the longitudinal axis.
the first part comprises at least one rounded face that is designed to be in contact with the coil head. This heat sink thus makes it possible to protect the wires forming the coils, by having a rounded face, while also providing a maximum surface for heat exchange with the coil head in order to cool the coil heads. Indeed, whether the winding be distributed or single-tooth, a rounded face of this kind prevents the wires from breaking during the winding step.
the common base comprises a rounded face that extends from a vertical planar face. A structure of this kind is suitable for a stator having a single-tooth winding. Alternatively, the common base may comprise a polygonal face, for example rectangular or square. An alternative of this kind is suitable in particular for a stator having a distributed winding.
each blade extends in a plane perpendicular to a plane in which the vertical planar face of the common base extends.
the first part of the heat sink is hollow. This thus makes it possible to reduce the total mass, as well as the parts exposed to heating owing to the variable magnetic fields of the electric machine.
the first part of the heat sink has a U-shaped cross section. In other words, the first part is hollow and open over the length thereof. The cross section of the first part is taken in a cutting plane that is transverse to the first part, the cutting plane being contained in a reference plane defined by the longitudinal and transverse axes of the heat sink.

A heat-dissipation member for a rotary electric machine is also disclosed. The heat-dissipation member comprises a plurality of heat sinks as defined above.

A heat-dissipation member of this kind makes it possible, when installed on a rotary electric machine, to ensure cooling of a plurality of coil heads on one side of the electric machine. This dissipation member is formed in one piece.

According to different features of the heat-dissipation member, taken individually or in combination, it may be possible that:
the heat sinks are interconnected by the common bases thereof. The first and second parts of the heat sinks thus remain free, making it possible to ensure heat exchange. The connection between the heat sinks is understood to be a mechanical connection. The heat sinks are preferably molded or welded together.
the heat-dissipation member is structured as a crown. A crown is intended to mean that the heat-dissipation member comprises a plurality of heat sinks that substantially form a circle or a ring. The circular shape has the advantage of being easy to integrate into a rotary electric machine, at the longitudinal end of this machine. A crown of this kind makes it possible, when installed on a rotary electric machine, to ensure cooling of all the coil heads on one side of the electric machine. This crown may be formed in one piece.
the interconnected common bases define a central volume of the crown and have a cross section in the shape of an N-sided polygon, where N is equal to the number of heat sinks contained in the heat-dissipation member. Of course, the central volume of the crown is interrupted by the first parts of the heat sinks which are directed towards the center of the crown. The polygonal cross section is achieved according to a reference plane defined by the vertical and transverse axes of the crown, as defined by a trihedral. A geometry of this kind makes it possible to ensure that the bases of the heat sinks rest on the outer surfaces of the coil heads.
each blade extends in a radial manner relative to a center of the crown. This orientation of the blades makes it possible to optimize the number of these blades provided on the crown, and to not interrupt a circulation of a cooling fluid that can travel along the electric machine.

Also disclosed is a rotary electric machine, comprising:
a plurality of coils,
a stator on which the plurality of coils is wound, the plurality of coils comprising coil heads, each coil head extending beyond the stator in the longitudinal direction and comprising a cavity,
a rotor that is movable inside the stator by means of a shaft, wherein this electric machine comprises at least one heat sink or at least one heat-dissipation member as defined above.

Ideally, the electric machine comprises two dissipation members that are each structured as a crown, the crowns being placed on each of the vertical outer faces of the stator of the electric machine.

According to different features of the rotary electric machine, taken individually or in combination, it may be possible that:
the stator comprises an outer surface on which vanes extend.
the vanes are aligned with at least one of the blades of the sink or of the dissipation member, as these blades are defined above.
the vanes are aligned with each blade of the heat sink or with each blade of the heat-dissipation member, as these blades are defined above.
the rounded face of the first part of the heat sink is in contact with the cavity defined by the coil head.
the heat sink or the heat-dissipation member is placed against a vertical face of the stator, in particular a vertical outer face of the stator.

### DESCRIPTION OF THE FIGURES

Further features, details and advantages of the claimed invention will emerge more clearly from reading the description given below, by way of example and with reference to the drawings, in which:

FIG. 1 is a perspective view of a heat sink,

FIG. 2 is a front view of a heat-dissipation member structured as a heat-dissipation crown,

FIG. 3 is a perspective view of the rear face of the heat-dissipation member of FIG. 2,

FIG. 4 is a perspective view of an electric machine equipped with a plurality of heat sinks,

FIG. 5 is a perspective view of an electric machine equipped with two heat sinks, structured as a crown,

FIG. 6 is a partial view of the electric machine of FIG. 5,

FIG. 7 is a longitudinal sectional view of the electric machine of FIG. 5, without flanges,

FIG. 8 is a longitudinal sectional view of the electric machine of FIG. 5, provided with a jacket.

### DETAILED DESCRIPTION

It should first be noted that the figures disclose the invention in a detailed manner in order to implement the claimed invention, it of course being possible for the figures to be used to better define the claimed invention, if necessary. It should be noted that the figures disclose a plurality of possible embodiments and variants of the claimed invention, without in any way limiting the scope of the claimed invention.

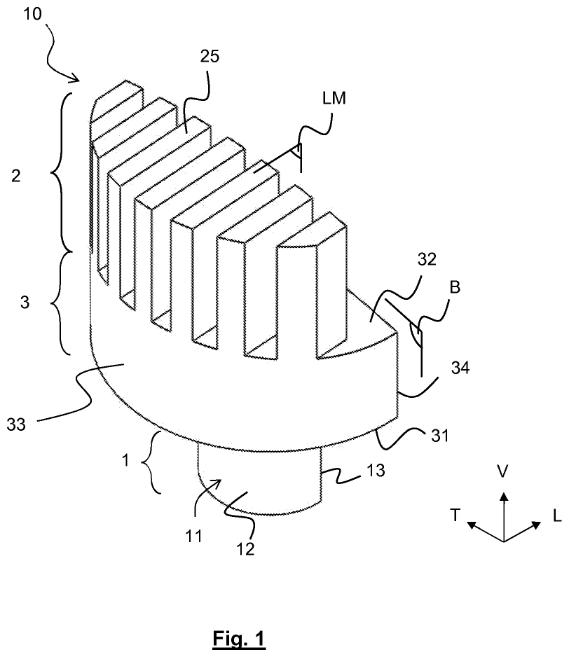

In the following description, relating to an individual heat sink, reference will be made to an orientation according to the longitudinal L, vertical V and transverse T axes, as these are defined arbitrarily by the trihedral L, V, T shown in FIG. 1. The choice of the names of these axes does not limit the orientation that the individual heat sink may assume in its application to a dissipation member or to a rotary electric machine.

FIG. 1 shows a heat sink 10, in this case an individual heat sink, for a rotary electric machine, comprising a first part 1 that is designed to be in contact with a coil head of the rotary electric machine. The heat sink 10 is referred to as an individual because it is intended, in this case, to be in contact with just one coil head. The heat sink 10 also comprises a second part 2 which is separate from the first part 1, ensuring heat exchange with the external environment. The first and the second parts 1, 2 are thermally coupled; that is to say that there is heat exchange between the first and the second parts 1, 2. The second part 2 thus makes it possible to cool the first part 1.

The first part 1 and the second part 2 extend from a common base 3. More specifically, each of the parts 1, 2 extends from an opposite face of the common base 3. The first part 1 thus extends from a lower face 31 of the common base 3, while the second part 2 extends from an upper face 32 of the common base 3. The lower face 31 and the upper face 32 are defined along the vertical axis V. The first part 1, second part 2, and common base 3 form one integral piece.

The first part 1 is designed to be accommodated inside a cavity delimited by the coil head. For this purpose, the first part 1 may be in the shape of a finger 11, having a cross section that comprises a circular arc. The finger 11 comprises a rounded face 12 and a vertical planar face 13. The rounded face 12 is the face that is intended to come into contact with the coil head, a rounded face 12 of this kind making it possible to simultaneously provide a maximum heat exchange surface and protection of the wires forming the coil during the winding step. In the embodiment shown, the finger 11 in this case has a semi-circular cross section, the cross section being achieved according to a plane defined by the longitudinal axis L and the transverse axis T.

The first part 1 may be hollow, in order to reduce the mass of the heat sink 10 as well as the masses exposed to heating owing to the variable magnetic fields of the electric machine. In addition to being hollow, the first part 1 may have a U-shaped cross section, being open on the vertical planar face 13 thereof, as will be described in the following.

The common base 3, more particularly the lower face 31 thereof, is designed to be in contact with an upper surface of the coil head.

In the embodiment shown in FIG. 1, the common base 3 has a cross section that comprises a circular arc, the cross section being achieved according to a plane defined by the longitudinal axis L and the transverse axis T. In this case, the common base 3 has a semi-circular cross section. The common base 3 thus comprises, in addition to the lower face 31 thereof and the upper face 32 thereof, a rounded face 33 that extends from a vertical planar face 34. The vertical planar face 34 extends in a plane B that is defined by the vertical axis V and the transverse axis T.

The semi-circles that form the first part 1 and the common base 3 of the heat sink 10 extend from the same center and have different radii. Indeed, the semi-circle that defines the finger 11 has a smaller radius than the semi-circle that defines the common base 3.

Furthermore, the second part 2, which ensures heat exchange with the external environment, in this case comprises a plurality of blades 25. These blades 25 make it possible to increase the heat exchange surface between the second part 2 and the external environment, and the cooling is thus improved. Each blade 25 extends in a plane LM that is defined by the vertical axis V and the longitudinal axis L. The plane LM is preferably perpendicular to the plane B in which the vertical planar face 34 of the common base 3 extends. In a non-limiting manner, the plane LM could also be parallel with or oblique to the plane B. The blades 25 are opposite the first part 1, with respect to the common base 3. Viewed in a reference of the rotary machine intended to receive the heat sink, the blades 25 extend radially and towards the outside of the rotary machine. The first part 1, in turn, extends radially and towards the inside of the rotary machine, i.e. towards the axis of rotation thereof.

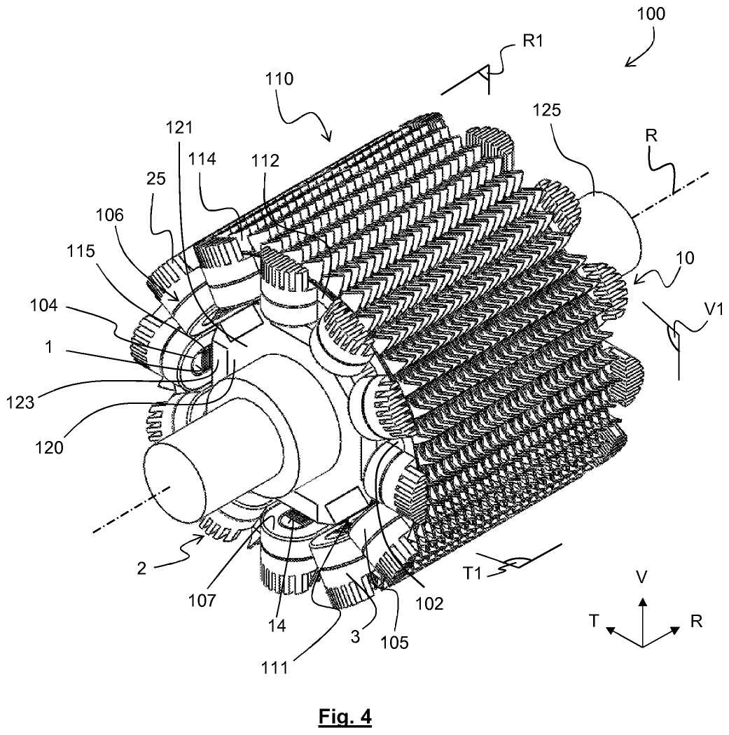

According to the embodiment shown in FIG. 1, the blades 25 have variable lengths along the longitudinal axis L of the heat sink 10. More specifically, the blades 25 follow the circular arc of the common base 3. In other words, the blades 25 extend from the rounded face 33. Furthermore, the blades 25 extend, in length, on the common base 3 in part. Indeed, proceeding from the rounded face 33, the blades 25 end before reaching the vertical face 34, in order to define free a space for the cooling vanes which emerge peripherally from a stator of the rotary machine (see in particular FIG. 4). Alternatively, the blades 25 may extend longitudinally on the common base 3, from the rounded face 33 to the vertical face 34. It should also be noted that the blades in this case have a constant height along the vertical axis V of the heat sink 10. Of course, the blades 25 could be of mutually different heights.

Of course, in order to ensure the dissipation role thereof, the heat sink 10 may be formed of a thermally conductive material which heats up only slightly under the effect of a variable magnetic field. A material of this kind allows for improved heat transfer. This material may, for example, be aluminum, a non-magnetic steel, titanium, or an alloy based on these metals, or even a synthetic material loaded with heat-conducting fibers.

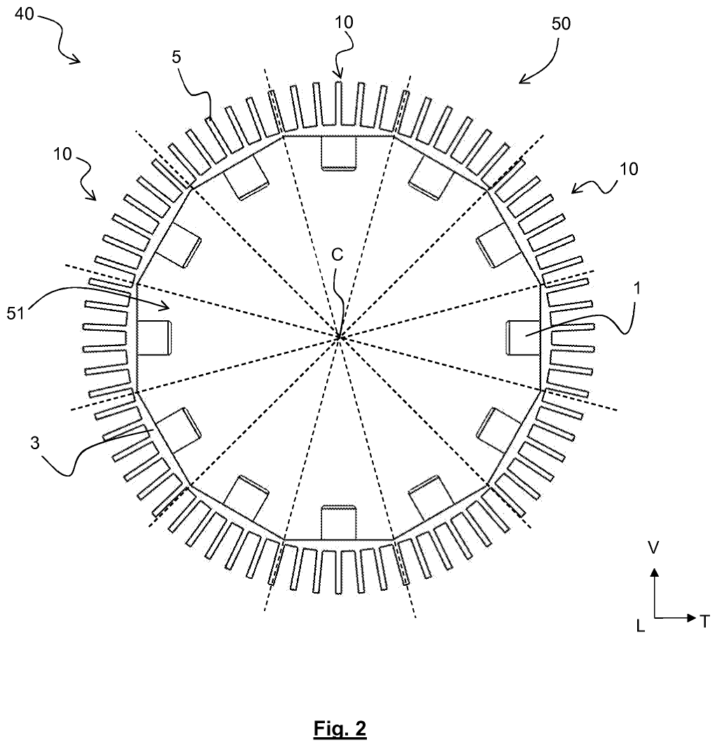

FIG. 2 shows a plurality of heat sinks 10 that are mutually assembled in order to form a dissipation member 40. Each individual heat sink 10 is connected to neighboring heat sinks 10 by the common base 3 thereof. The first part 1 and the second part 2 of each heat sink 10 that forms part of the dissipation member thus remain free, making it possible to ensure thermal cooling of the coil heads. Of course, the heat sinks 10 could be interconnected by the first part 1 or the second part 2.

The common bases 3 are interconnected by a connection of the mechanical type, i.e. they may for example be welded or molded together. The dissipation member 40 is thus formed in one piece, i.e. made of a single part.

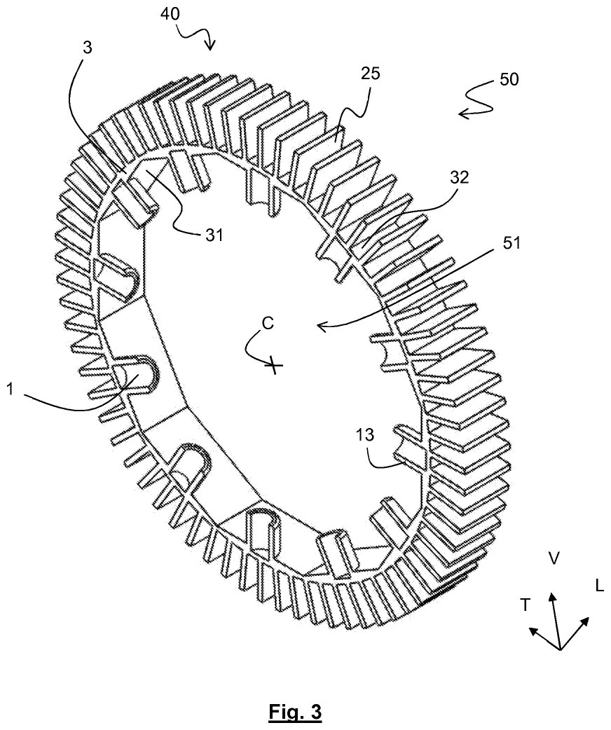

According to the embodiment shown in FIGS. 2 and 3, the dissipation member 40 is structured as a crown 50. A crown 50 is intended to mean that the heat-dissipation member 40 comprises a plurality of heat sinks 10 that substantially form a closed circle. In this case, the heat-dissipation member 40 comprises twelve heat sinks 10 that are structured as a crown 50. The circular shape of the crown 50 has the advantage of being easy to integrate into a rotary electric machine. A crown 50 of this kind makes it possible, when installed on a rotary electric machine, to ensure cooling of all the coil heads on one of the sides of the electric machine. This crown 50 may be formed in one piece or in two pieces, in order to facilitate the placement thereof in the electric machine. It should be noted that the heat-dissipation member 40 may assume any other shape, such as a square, a circular arc or a triangle, depending on the requirements.

In the following description, the relative concepts such as “inner” or “outer” are defined with respect to a center C of the crown 50. The concept of “inner” means, according to the center, that the element in question is located or is directed radially towards the inside of the crown 50, towards the center C thereof, whereas the concept “outer” means, according to this reference point, that the element in question is located or is directed radially to the outside of the crown 50 with respect to the center C. In the same manner as for the heat sink 10, reference will be made to an orientation according to the longitudinal L, vertical V and transverse T axes, as these are defined arbitrarily by the trihedral L, V, T shown in FIG. 2 or 3. The choice of the names of these axes does not limit the orientation that the crown 50 may assume in its application to the rotary electric machine.

As can be seen in particular in FIG. 3, each common base 3 has a rectangular cross section, according to a plane defined by the longitudinal axis L and the transverse axis T. The common base 3 can thus have a rectangular upper face 31 and a rectangular lower face 32.

The interconnected common bases 3 define a central volume 51 of the crown 50. The first part 1 of each heat sink 10 lead into this central volume 51. Furthermore, the common bases 3 define a cross section in the shape of an N-sided polygon, where N is equal to the number of heat sinks 10 contained in the heat-dissipation member 40. The number N of sides of the polygonal cross section can preferably also be equal to the number of teeth of the stator. The polygonal cross section is achieved according to a plane contained in a reference defined by the vertical and transverse axes of the crown, as defined by the trihedral of FIGS. 2 and 3. A geometry of this kind makes it possible to ensure that the common bases 3 of the heat sinks 10 rest on the outer surfaces of the coil heads. In the example shown, the vertical polygonal cross section has twelve sides.

In this case, the blades 25 extend radially with respect to the center C of the crown 50 and follow an axial direction of the crown 50, i.e., in accordance with the longitudinal axis L. This orientation of the blades 50 makes it possible to optimize the number of these blades provided on the crown 50, and to not interrupt a circulation of a cooling fluid that can travel along the electric machine. Of course, the blades 25 could be oriented differently. Indeed, the blades 25 could extend according to the transverse axis T of the crown 50 or could be oblique with respect to the longitudinal axis L of the crown 50.

Furthermore, in this case the blades 25 are all of identical lengths along the longitudinal axis L of the crown 50 and extend entirely over the common base 3. Of course, the blades 25 could extend on the common base 3 in part and be of different lengths. It should also be noted that the blades in this case have a constant height along the vertical axis V of the crown 50. Of course, the blades 25 could be of mutually different heights.

As can be seen in particular in FIG. 3, the first part 1 has a U-shaped cross section, being entirely open on the vertical planar face 13 thereof, the cross section being achieved in a plane defined by the longitudinal axis L and the transverse axis T for a first part 1 that extends according to the vertical axis V. This U-shaped cross section makes it possible to lighten the masses and makes it possible to form the rounded face 12 so as to have the same curvature as the cavity formed by the coil heads.

A rotary electric machine 100 will now be described which, according to a first embodiment shown in FIG. 4, comprises individual heat sinks 10.

In the following description, the relative concepts such as “inner,” “lower,” “outer” or “upper” are defined with respect to an axis of rotation R that is defined as the axis about which a shaft 125, driving a rotor 120 of the electric machine, rotates. The concept of “lower” means, according to this reference point (i.e., the axis of rotation), that the element in question is located or is directed radially towards the inside of the electric machine, approaching the axis of rotation R, whereas the concept “upper” means, according to this reference point, that the element in question is located or is directed radially towards the outside of the electric machine, moving away from the axis of rotation R. The concept of “inner” means, according to this reference point, that the element in question is located or is directed longitudinally towards the inside of the electric machine, approaching a center of the electric machine, whereas the concept “outer” means, according to this reference point, that the element in question is located or is directed longitudinally towards the outside of the electric machine, moving away from the center of the electric machine. A longitudinal axis is defined as the axis according to which the length of the electric machine extends. The longitudinal axis and the axis of rotation R of the electric machine thus coincide. The longitudinal axis L described above for the heat sink(s), and the axis of rotation R of the machine, also coincide.

Three reference planes are defined: a vertical plane V1, a radial plane R1 and a tangential plane T1. The vertical plane V1 is perpendicular to the axis of rotation R of the rotor 120. In other words, the vertical plane V1 may correspond to a vertical face of the stator 110. The radial plane R1 is in parallel with the axis of rotation R of the rotor 120 and passes therethrough. In other words, the radial plane R1 may correspond to an exposed face of the electric machine in a longitudinal section. The tangential plane T1 is also in parallel with the axis of rotation R of the rotor 120 but does not pass through the axis of rotation R of the rotor 120. The tangential plane T1 would be exposed if the stator 110 were cut along the length thereof, slightly below the outer surface thereof.

FIG. 4 shows a stator 110 and a rotor 120 of the rotary electric machine 100. Windings forming coils 102 are mounted on the stator 110 and, for example, permanent magnets 123 are fixed to the rotor 120. The rotor 120, formed from a stack of rotor laminations 121, is rotatable by means of a shaft 125, about the axis of rotation R.

In this embodiment, a stack of laminations 112 forms the stator 110. The laminations 112 comprise at least one vane 114 and at least one tooth 115. In this case, each lamination 112 comprises four vanes 114. The laminations 112 are thus stacked such that the vanes 114 of a given lamination 112 are offset relative to the adjacent laminations 112. Moreover, each lamination 112 comprises a number D of teeth 115, the number D being equal to the number of coils. Thus, in the embodiment shown, each lamination 112 comprises twelve teeth 115.

At the longitudinal ends of the stator 110, individual heat sinks 10 are placed on the two end laminations 112 of the stator 110, more precisely on the vertical outer faces of the stator 110. The wires that form the coils 102 are thus wound around the teeth 115 provided on the laminations 112 of the stator 110, passing through the first part 1 of the heat sink 10. More precisely, the wires that form the coils 102 come into contact with the rounded face 12 of the first part 1. This rounded face 12 thus makes it possible to not break the wires during the winding process. Indeed, the wires that form the coils 102 may be wound in a manner known as single-tooth, i.e. around one single tooth of the stator 110, or in a manner known as distributed, where the coils are wound around a plurality of teeth 115 of the stator 110. In each case, the formation of folds that are too definite, which risk damaging the wires of the coil head, is prevented.

At the ends of the stator 110, the winding of the coils 102, whether distributed or single-tooth, makes it possible to form coil heads 105. Each coil head 105, which is wound around an individual sink 10, forms a cavity 104 in which the first part 1, in this case the finger 11, of the individual sink 10 is accommodated. In this embodiment, all the coil heads 105 are provided with an individual sink 10. Of course, the situation may be different in the case of one coil head 105 in two or in three that is provided with an individual sink 10, which would make it possible to further reduce the mass of the electric machine.

Furthermore, it should be noted that the lower face 31 of the common base 3 of each individual sink 10 rests on the upper surface 106 of each of the coil heads 105. The vertical end face 14 of the first part 1, in turn, is flush with the lower surface 107 of the coil heads 105.

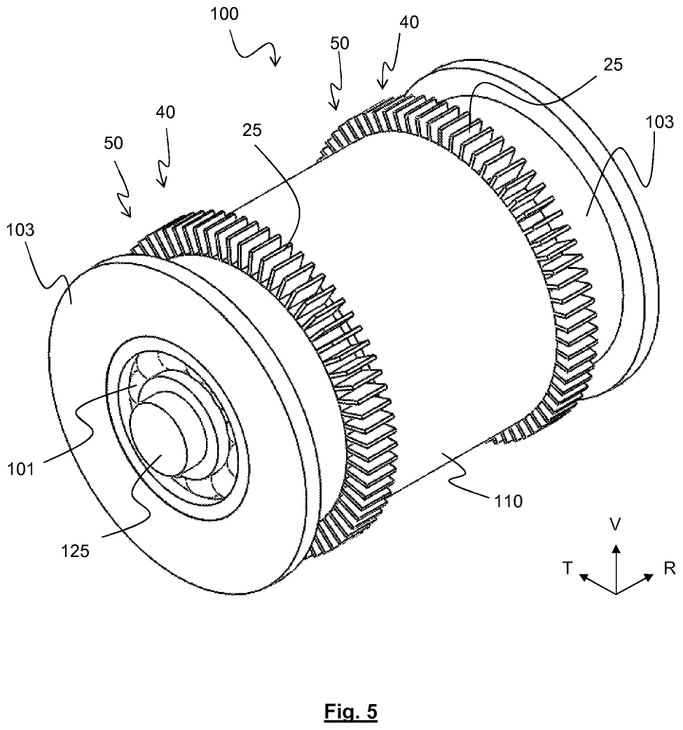

A rotary electric machine 100 will now be described which, according to a second embodiment shown in FIGS. 5 to 8, comprises at least one heat-dissipation member 40. More particularly, in this case the heat-dissipation member 40 is in the shape of a crown 50. The electric machine 100 thus comprises two dissipation members 40 that are structured as crowns 50, and each crown 50 is thus placed on each of the vertical outer faces of the stator 110, on either side of the electric machine 100, along the axis of rotation R.

To facilitate the legibility of FIGS. 5 to 8, the stator 110 has been shown in this case in one piece, but it could equally be formed from a stack of laminations 112.

As shown in FIG. 5, the shaft 125 that rotates the rotor is rotatably carried by a rotary bearing 101, it being possible for this bearing to be for example a needle ball bearing or a friction bearing. The rotary bearing 101, in turn, is supported by a flange 103 of the electric machine 100. An electric machine 100 may thus comprise two flanges 103 and two rotary bearings 101 that are located at the two longitudinal ends of the electric machine 100. Each crown 50 is thus inserted between one of the flanges 103 and the stator 110.

It should be noted that the blades 25 of the crown 50 do indeed extend in a radial plane of the electric machine 100 or of the crown 50, allowing for a circulation of a fluid along the electric machine 100.

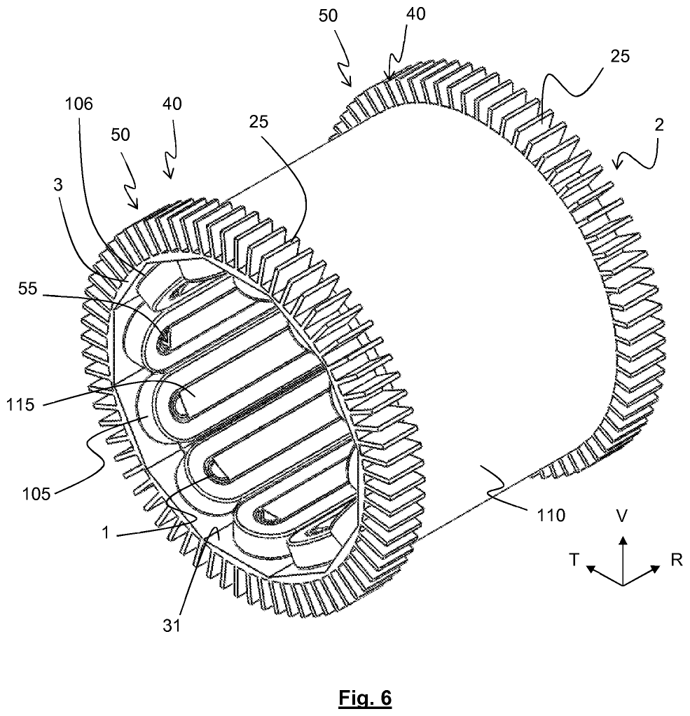

For the sake of improved clarity, FIG. 6 shows only the stator 110 on which the coils 105 and the two crowns 50 are mounted. It can thus be seen that the first parts 1 are hollow and have a U-shaped cross section. A U-shaped cross section of this kind thus makes it possible to create a space 55 between the first part 1 and the tooth 115 of the stator 110.

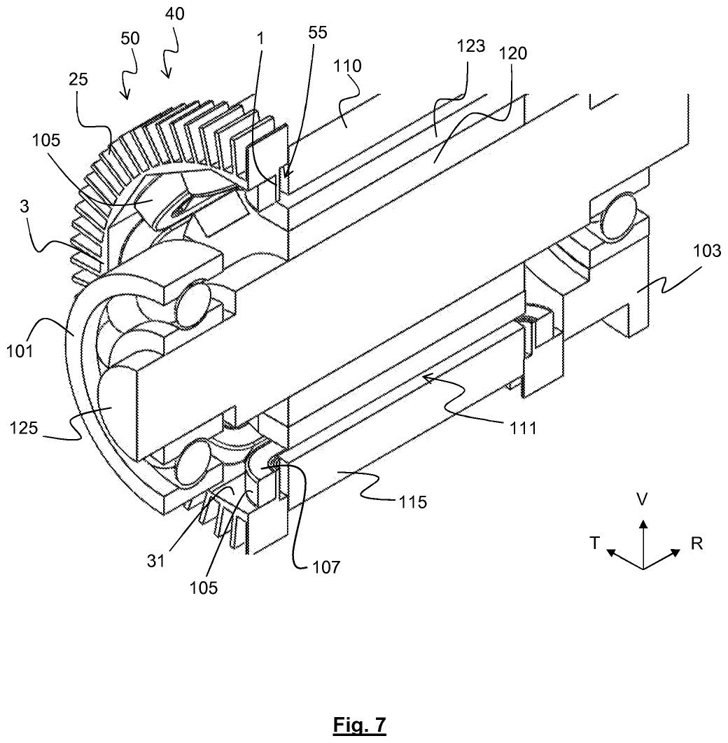

It can also be seen that the polygonal cross section of the crown 50, in this case having 12 sides, which is formed by the common bases 3 of the heat sinks 10, rests on the upper surface 106 of the coil heads 105, and that the blades 25 of the crown 50 do indeed extend in a radial plane of the electric machine 100 or of the crown 50. This can be seen particularly clearly in FIG. 7, which is a longitudinal sectional view of the electric machine 100, shown without the flanges 103 thereof.

FIG. 7 shows this longitudinal section made in a radial plane of the rotary electric machine 100. This section makes it possible to show that the first parts 1 of the crown 50 end flush with the inner surface 107 of the coil heads 105. In other words, the first parts 1 do not extend in an air gap 111, this air gap being defined as the space located between the stator 110 and the rotor 120.

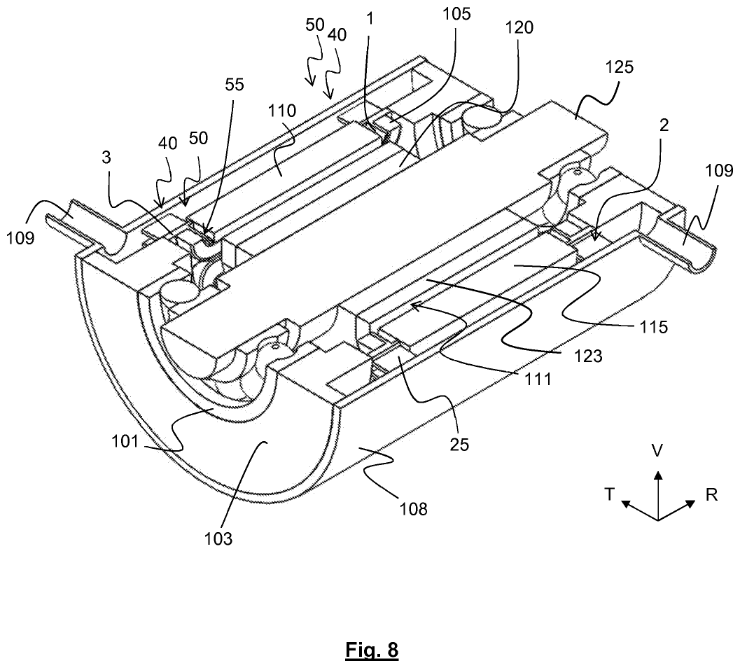

FIG. 8 shows a variant of the electric machine 100 which is equipped in this case with a jacket 108. This electric machine 100 comprises two dissipation members 40 that are structured as a crown 50, but could equally comprise individual sinks 10.

FIG. 8 shows a longitudinal section that passes through the axis of rotation R of the rotary electric machine 100. The jacket 108 covers the flanges 103 and the stator 110. The covering is achieved according to the axis of rotation R in which the electric machine 100 extends. This jacket 108 makes it possible to confine the cooling fluid flow, whether this be liquid or gaseous, so as to concentrate the flow on the outer peripheral wall of the stator.

The blades 25 of the crown 50 are oriented in the direction of the length of the electric machine 100 and are slightly spaced apart from the jacket 108. Such an arrangement of the blades 25 facilitates a circulation of a fluid that enters via a sleeve 109 and leaves via another sleeve 109 located, in this embodiment, at an end that is diametrically and longitudinally opposed to the jacket 108 that covers the electric machine 100. The circulation of the cooling fluid from one sleeve 109 to the other also makes it possible to cool the stator 110, and this can preferably be improved by way of the presence of vanes on the surface of this stator.

The description above clearly explains the way in which the invention makes it possible to achieve the objects which it addresses, and in particular to propose an efficient heat sink that is suitable for an electric machine of a reduced size. The invention has a plurality of advantageous applications, whether it be an individual heat sink or a heat-dissipation member that is structured as a closed crown or as a plurality of heat sinks forming angular sectors of the rotary electric machine.

Of course, a person skilled in the art may make various modifications to the individual heat sink or to the heat-dissipation member that has just been described by way of non-limiting example, insofar as at least one first part is used that is designed to be accommodated inside a cavity delimited by the coil head, and at least one second part which is separate from the first part, ensuring heat exchange with an external environment, the second part being thermally coupled to the first part.

In any case, the invention is not limited to the embodiments specifically described in this document, and extends in particular to all equivalent means and to any technically feasible combination of these means.

1. A heat sink for a rotary electric machine, comprising:
a first part that is designed to be in contact with a coil head of the rotary electric machine,
a second part which is separate from the first part, ensuring heat exchange with the external environment, the second part being thermally coupled to the first part,
wherein the first part is sized and shaped to be accommodated inside a cavity delimited by the coil head.

2. The heat sink according to claim 1, wherein the heat sink includes a common base; and wherein the first part and the second part each extend from an opposite face of the common base.

3. The heat sink according to claim 2, wherein the common base is shaped to be in contact with an upper surface of the coil head.

4. The heat sink according to claim 1, wherein the second part comprises at least one blade that ensures heat exchange with the external environment.

5. The heat sink according to claim 1, wherein the first part comprises at least one rounded face that is designed to be in contact with the coil head.

6. The heat sink according to claim 5, wherein the second part comprises at least one blade that ensures heat exchange with the external environment; and wherein the common base comprises a vertical planar face defining a plane; the at least one blade extending in a plane perpendicular to the plane defined by the vertical planar face of the common base.

7. The heat sink according to claim 1, wherein the first part is hollow.

8. A heat-dissipation member for a rotary electric machine, the heat-dissipation member comprising a plurality of heat sinks according to claim 1.

9. The heat-dissipation member according to claim 8, wherein each heat sink includes a common base, the first part and the second part of each heat sink extending from an opposite face of the common base, and wherein the heat sinks are interconnected by their common bases.

10. The heat-dissipation member according to claim 8, wherein the heat-dissipation member is structured as a crown.

11. The heat-dissipation member according to the claim 10, wherein each heat sink includes a common base, the first part and the second part each heat sink extending from an opposite face of the common base, and; the heat sinks being interconnected by their common bases; and wherein the interconnected common bases define a central volume of the crown and have a cross section in the shape of an N-sided polygon, where N is equal to the number of heat sinks contained in the heat-dissipation member.

12. The heat-dissipation member according to claim 10, wherein the second part comprises at least one blade that ensures heat exchange with the external environment, and wherein the at least one blade extends in a radial manner with respect to a center of the crown.

13. A rotary electric machine, comprising:
a plurality of coils,
a stator on which the plurality of coils is wound, the plurality of coils comprising coil heads, each coil head extending beyond the stator in the longitudinal direction and delimiting a cavity,
a rotor that is movable inside the stator by means of a shaft,
wherein the electric machine comprises at least one heat sink defined according to claim 1, or at least one heat-dissipation member comprised of a plurality of said heat sinks.

14. The rotary electric machine according to claim 13, wherein the stator comprises an outer surface from which vanes extend.

15. The rotary electric machine according to claim 13, wherein the heat sink or the heat-dissipation member is placed against a vertical face of the stator.
